(19) United States
(12) Patent Application Publication
(10) Pub. No.: US 2023/0261344 A1
(43) Pub. Date: Aug. 17, 2023

(54) BATTERY CELL

(71) Applicant: Dr. Ing. h.c. F. Porsche Aktiengesellschaft, Stuttgart (DE)

(72) Inventors: Urs Hanig, Tubingen (DE); Tim Schmidt, Freiberg am Neckar (DE); Benjamin Passenberg, Rutesheim (DE); Markus Göhring, Nufringen (DE); Mathias Zilly, Pfinztal (DE); Gorazd Balejik, Prag (CZ)

(73) Assignee: Dr. Ing. h.c. F. Porsche Aktiengesellschaft, Stuttgart (DE)

(21) Appl. No.: 18/105,352

(22) Filed: Feb. 3, 2023

(30) Foreign Application Priority Data
Feb. 17, 2022 (DE) 10 2022 103 726.6

(51) Int. Cl. H01M 50/553; H01M 50/533; H01M 50/176; H01M 50/103; H01M 50/548; H01M 50/562

(52) U.S. Cl. CPC H01M 50/553; H01M 50/103; H01M 50/176; H01M 50/533; H01M 50/548; H01M 50/562; H01M 2220/20

(57) ABSTRACT

A battery cell includes a housing, an electrode stack assembly, and at least one terminal assembly. The electrode stack assembly is arranged in the housing and includes first electrode assemblies and second electrode assemblies. The first electrode assemblies include first electrodes and first strip elements. The second electrode assemblies include second electrodes and second strip elements. At least one terminal assembly includes a base part and a counter-element, which base part includes a first contact face and the counter-element includes a second contact face. The counter-element resiliently engages with at least one groove-like recess of the base part in such a way that a first force is applied to the first contact face and the second contact fact, pushing them towards one another. The first strip elements or second strip elements are arranged between the first contact face and the second contact face.

### CROSS-REFERENCE TO RELATED APPLICATION

This application claims priority to German Patent Application No.: 10 2022 103 726.6, filed Feb. 17, 2022, the content of such application being incorporated by reference herein in its entirety.

### FIELD OF THE INVENTION

The invention relates to a battery cell.

### BACKGROUND OF THE INVENTION

DE 42 18 381 C1, which is incorporated by reference herein, discloses an accumulator cell in which pressure plates are arranged within a cell housing.

WO 2006 / 046 585 A1, which is incorporated by reference herein, discloses a foil battery with a composite element consisting of two parts and a pressing element.

US 10 056 587 B2, which is incorporated by reference herein, discloses a battery with a cell stack.

JP 2007-265 945 A, which is incorporated by reference herein, discloses a battery with an integrated laminate cell.

FR 2 797 717 A1, which is incorporated by reference herein, discloses a manufacture of a battery with a welding machine.

### SUMMARY OF THE INVENTION

A battery cell comprises a housing, an electrode stack assembly, and at least one terminal assembly, which electrode stack assembly is arranged in the housing and comprises first electrode assemblies and second electrode assemblies, which first electrode assemblies comprise first electrodes and first strip elements, which second electrode assemblies comprise second electrodes and second strip elements, which at least one terminal assembly comprises a base part and a counter-element, which base part comprises a first contact face, which counter-element comprises a second contact face, which counter-element resiliently engages with at least one groove-like recess of the base part in such a way that a first force is applied to the first contact face and the second contact fact, pushing them towards one another, wherein first strip elements or second strip elements are arranged between the first contact face and the second contact face, wherein the base part is configured so as to be electrically conductive and forms a connecting element, which connecting element can be contacted from the outside of the housing, and which base part is electrically connected to the first electrodes via the first strip elements or to the second electrodes via the second strip elements.

A clamping of the strip elements allows a good electrical connection between the electrically conductive strip elements and the terminal assembly. Additional connections such as welded joints can be omitted.

According to a preferred embodiment, the first electrodes are positive electrodes and the second electrodes are negative electrodes, or vice versa.

According to a preferred embodiment, the base part comprises two first contact faces, which are provided on two opposite sides of the base part. This is advantageous for a division of the strip elements into two substacks.

According to a preferred embodiment, the base part extends through the housing and forms the connecting element on the outside of the housing. The base part collects the strip elements and provides them as a pole on the outside of the housing.

According to a preferred embodiment, the base part extends through a housing wall, and the counter-element is arranged on the inside of the housing wall. This arrangement advantageously protects the clamping connection from the outside by the housing.

According to a preferred embodiment, the housing has a basic cuboid shape with a first housing side, a second housing side, a third housing side, a fourth housing side, a fifth housing side, and a sixth housing side, which first housing side is provided opposite to the second housing side, which third housing side is provided opposite to the fourth housing side, and which fifth housing side is provided opposite to the sixth housing side.

According to a preferred embodiment, the at least one terminal assembly comprises a first terminal assembly and a second terminal assembly, and the first terminal assembly is provided on the first housing side and the second terminal assembly is provided on the second housing side. This results in short connection paths and a compact design of the battery cell.

According to a preferred embodiment, the base portion comprises copper or a copper alloy. Copper is a good conductor. On the other hand, it is very difficult to weld strip elements made of aluminum or an aluminum alloy with a copper part. In the present case, because a clamping connection is possible, no welding connection is required, and copper can be used.

According to a preferred embodiment, the base part comprises a groove-like recess, the base part forms the first contact face in the region of the groove-like recess, and the first strip elements or the second strip elements extend into the groove-like recess, and the counter-element is configured as a spring element with the second contact face, the counter-element extends at least in sections into the groove-like recess and resiliently abuts against the first contact face via the first strip elements or via the second strip elements.

According to a preferred embodiment, the groove-like recess comprises a first width in an inner region, at least in sections, which width is greater than a second width in an outer region of the groove-like recess, in order to thereby enable a retaining effect of the counter-element in the groove-like recess.

According to a preferred embodiment, in the region of the groove-like recess, the base part is concavely curved, at least in sections, in order to reduce the risk of damage to the first strip elements or the second strip elements. A curved configuration is effective against mechanical destruction of the thin strip elements.

According to a preferred embodiment, the counter-element is configured as a profile part, which has a first curvature direction in the profile in a first curvature region and two free ends, wherein the first curvature region is arranged at least in sections in the groove-like recess and at least one of the free ends protrudes out of the groove-like recess, wherein both free ends preferably protrude out of the groove-like recess. This allows for easy assembly.

According to a preferred embodiment, the first curvature region passes through an angular range of at least 185°.

According to a preferred embodiment, the counter-element comprises in the profile between the first curvature region and at least one of the free ends, at least in sections, a second curvature region having a second curvature direction, which second curvature direction is opposite to the first curvature direction. This allows the free ends to be grasped better.

According to a preferred embodiment, the counter-element comprises two first protrusions having first free ends, which first protrusions approach one another at least in sections towards the free ends, and the base part comprises a second protrusion having a second free end, which extends into the region between the two first protrusions and widens at least in sections towards the second free end in order to cause a clamping connection between the base part and the counter-element through the interaction of the first projections with the second protrusion. This production of the connection is advantageous because it does not require a screw connection.

According to a preferred embodiment, the base part comprises two third protrusions, in which the first protrusions each extend into a region between the second protrusion and the associated third protrusion, which third protrusions form the first contact face, which first protrusions form the second contact face, and which first contact face is subjected to a force by the clamping connection between the base part and the counter-element towards the second contact face, wherein the first strip elements or the second strip elements extend between the first contact face and the second contact face. This allows for a secure pressing.

According to a preferred embodiment, two groove-like recesses are formed between the second protrusion and the third protrusions.

According to a preferred embodiment, the first protrusions are provided on opposite sides of the second protrusion. The transverse forces are thereby at least partially eliminated on the base part.

According to a preferred embodiment, at least one of the first protrusions comprises a spring element, which spring element is provided so as to allow for an increase of the distance between the two first protrusions upon application of a force.

According to a preferred embodiment, the at least one of the first protrusions comprises a slot, which slot is configured so as to allow the spring element to be deflected into the region of the slot.

### BRIEF DESCRIPTION OF THE DRAWING FIGURES

Further details and advantageous further developments of the invention will emerge from the embodiment examples, which are described below and illustrated in the drawings and are not to be construed as limiting the invention in any way, and from the subclaims. It goes without saying that the features mentioned above and those yet to be discussed below can be used not only in the respectively specified combination, but also in other combinations or on their own, without leaving the scope of the present invention. Here:

FIG. 1 shows, in a schematic view from above, a battery cell,

FIG. 2 shows, in a schematic view from the front, the battery cell of FIG. 1,

FIG. 3 shows, in a schematic view from the left, the battery cell of FIG. 1,

FIG. 4 shows, in a side view, an electrode assembly,

FIG. 5 shows, in a plan view, the electrode assembly of FIG. 4,

FIG. 6 shows, in a longitudinally cut view, the battery cell of FIG. 1,

FIG. 7 shows, in a schematic plan view, the battery cell of FIG. 1 with a first embodiment of a base part in an assembled state,

FIG. 8 shows, in a schematic plan view according to FIG. 7, the battery cell with two provided counter-elements,

FIG. 9 shows, in a schematic plan view according to FIG. 8, the battery cell with two inserted counter-elements,

FIG. 10 shows, in a schematic plan view according to FIG. 9, the battery cell with two relaxed counter-elements,

FIG. 11 shows, in a schematic spatial view, the battery cell of FIG. 10,

FIG. 12 shows, in a schematic plan view, the battery cell of FIG. 1 with a second embodiment of a base part and a counter-element in an assembled state,

FIG. 13 shows, in a schematic plan view according to FIG. 12, the battery cell with the base part approaching the counter-element,

FIG. 14 shows, in a schematic plan view corresponding to FIG. 13, the battery cell with the base part and the counter-element after a joining operation, and

FIG. 15 shows, in a spatial view, the battery cell of FIG. 14.

### DETAILED DESCRIPTION OF THE INVENTION

Parts that are the same or have the same effect bear the same reference numerals in the following and are generally described only once. The descriptions of all of the figures build on one another in order to avoid unnecessary repetitions.

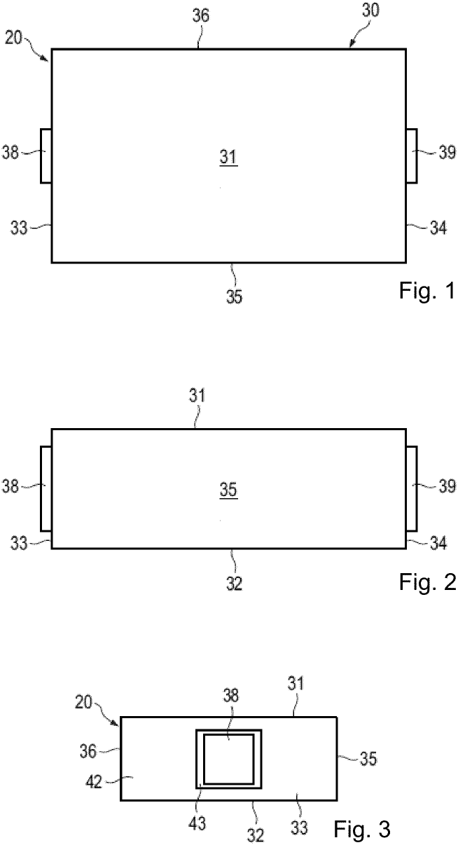

FIG. 1 shows a battery cell 20 from above. The battery cell 20 is configured as a prismatic cell and has a housing 30, a terminal element 38, and a terminal element 39.

The housing 30 has a basic cuboid shape with a housing side 31 (top), a housing side 33 (left), a housing side 34 (right), a housing side 35 (front), and a housing side 36 (rear). The housing side 33 is provided opposite to the housing side 34, i.e. they lie on opposite sides of the housing 30. The housing side 35 is provided opposite to the housing side 36. The connecting element 38 is provided on the housing side 33 and can be contacted on the housing side 33 from the outside. The connecting element 39 is provided on the housing side 34 and can be contacted on the housing side 34 from the outside. Battery cell 20 can provide electrical energy via terminal elements 38, 39, and terminal elements 38, 39 can also be referred to as poles.

FIG. 2 shows the battery cell 20 of FIG. 1 in a view from the housing side 35 (front).

The housing side 32 (bottom) is provided opposite to the housing side 31 (top).

FIG. 3 shows the battery cell 20 of FIG. 1 in a view from the housing side 33 (left). A housing wall 42 and the connecting element 38 are provided on the housing side 33. Preferably, an insulation element 43 is shown schematically between the terminal element 38, and the housing wall 42, and the insulation element 43 allows for an electrical insulation between the terminal element 38 and the housing wall 42. This allows the housing wall 42 to be formed from a conductive material, e.g. from a metal. Formation of the housing wall 42 from a thermally well conductive material, such as metal, allows a good heat dissipation of the heat generated in the battery cell 36 during operation.

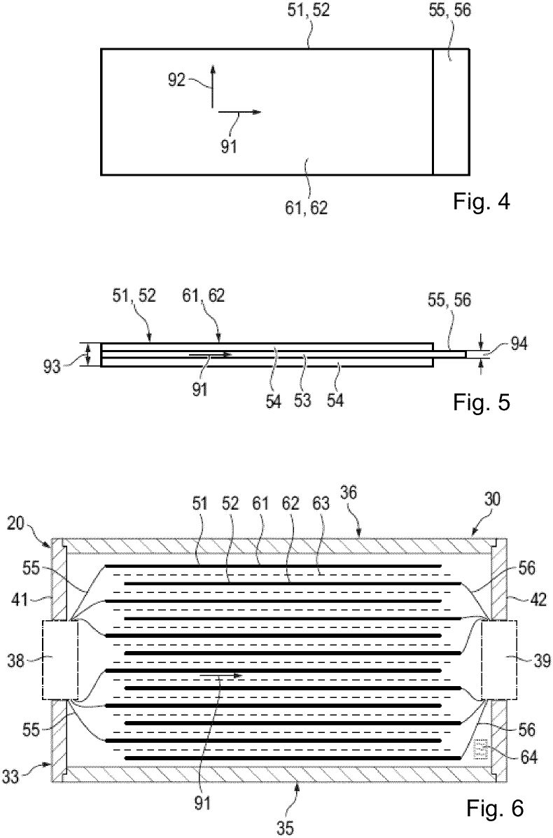

FIG. 4 shows in a side view an electrode assembly 51 or 52, which comprises an electrode 61 or 62 and a strip element 55 or 56, respectively. Such strip elements 55, 56 can be referred to as “tabs” and are used in order to contact the electrode 61 and/or 62.

The electrode 61 respectively 62 has a longitudinal direction 91 and a transverse direction 92 transverse to the longitudinal direction 91.

FIG. 5 shows, in a schematic plan view, the electrode assembly 51, 52 of FIG. 4.

The electrode assembly 51 respectively 52 comprises a film 53, which is also referred to as a conductor film and allows current to flow as an electrical conductor. In the region of the electrode 61, 62, an active material layer 54 is provided on one side of the film 53 or on both sides. The thickness 93 of the electrode 61, 62 is preferably in the range of 15 µm to 2 mm.

The strip element 55 or 56 is preferably free of the active material layer 54, completely or at least in regions, because this region is not effective for the galvanic cell, on the one hand, and is also usually less electrically conductive than the film 53, on the other hand. In addition, the strip element 55 or 56 without the active material layer 54 has a lower thickness 94 than in the region of the electrode 61 or 62, and this allows for better bending of the strip element 55 or 56 and a more compact construction in the contacting region with the associated connecting element 38 or 39.

The thickness 94 is preferably in the range of 4 µm to 50 µm.

Preferably, the battery cell is configured as a lithium ion battery cell.

In this case, the positive electrode assembly 51 preferably comprises a film 53 made of aluminum or an aluminum alloy, and the active material layer 54 preferably comprises an active material, such as
lithium cobalt(III) oxide,
lithium nickel manganese cobalt oxide,
lithium nickel cobalt aluminum oxide, or
lithium iron phosphate.

The negative electrode assembly 52 preferably comprises a film 53 of copper or a copper alloy, and the active material layer 54 preferably comprises an active material, such as
graphite,
nanocrystalline amorphous silicon,
lithium titanate, or
tin dioxide.

The active material layers 54 can each additionally comprise additives.

The battery cell 20 can also be constructed as another cell type, for example as a
sodium sulfur battery cell,
nickel-iron battery cell, or
nickel-zinc battery cell.

Preferably, the battery cell 20 is rechargeable, and such a battery cell 20 is also referred to as a secondary cell or secondary element.

The electrode assembly 51 can also be negative and the electrode assembly 52 can be positive, such that the connecting element 38 is negative and the connecting element 39 is positive.

FIG. 6 shows the battery cell 20 from above in a longitudinal section.

An electrode stack assembly 50 is provided in the housing 30, and the electrode stack assembly 50 comprises the electrode assemblies 51 and the electrode assemblies 52. The separators 63 are preferably provided between the electrodes 61 of the electrode assemblies 51 and the electrodes 62 of the electrode assemblies 52. In the embodiment example, electrodes 61 and electrodes 62 are provided in perpetual alternation. It is also possible to provide at least partially - e.g. in the middle - two equal electrodes 61 or two equal electrodes 62 adjacent to one another.

An electrolyte 64 is also provided in the housing 30 in order to allow an ion flow.

The electrodes 61 and 62 extend in their longitudinal direction 91 between the housing side 33 and the housing side 34. The longitudinal direction 91 can thus be defined relative to the housing sides 33, 34. Alternatively, the longitudinal direction 91 can be defined relative to the connecting elements 38, 39, because they are provided on the housing sides 33, 34. Preferably, all electrodes 61, 62 extend in the same longitudinal direction 91. However, the longitudinal direction 91 can also be at least partially somewhat different. The strip elements 55 of the electrode assemblies 51 are positioned on the side associated with the housing side 33 and the strip elements 56 are positioned on the side associated with the housing side 34.

The connecting element 38 is electrically connected to the electrodes 61 via the strip elements 55, and the connecting element 39 is electrically connected to the electrodes 62 via the strip elements 56.

The housing 30 comprises a housing wall 41 on the housing side 33 and a housing wall 42 on the housing side 34.

The terminal element 38 is preferably electrically insulated from the housing wall 41, and the terminal element 39 is preferably electrically insulated from the housing wall 42. This preferably provided electrical insulation 43 (cf. FIG. 3) allows a comparatively free choice of material for the housing walls of the housing 30. In particular, a short circuit of the two connecting elements 38, 39 is prevented due to an optionally electrically conductive housing wall. Due to the good thermal conductivity, metals are well suited as housing walls for the housing 30, for example aluminum, an aluminum alloy, or titanium. Insulation of the housing 30 from the terminal elements 38, 39 is particularly advantageous in the case of a series circuit of battery cells, because, in such a series circuit, the individual terminal elements 38, 39 can be at a comparatively high voltage compared to the reference point on the chassis of a vehicle.

The connecting elements 38, 39 are indicated schematically. Specific embodiment examples for the connecting elements 38, 39 are provided below.

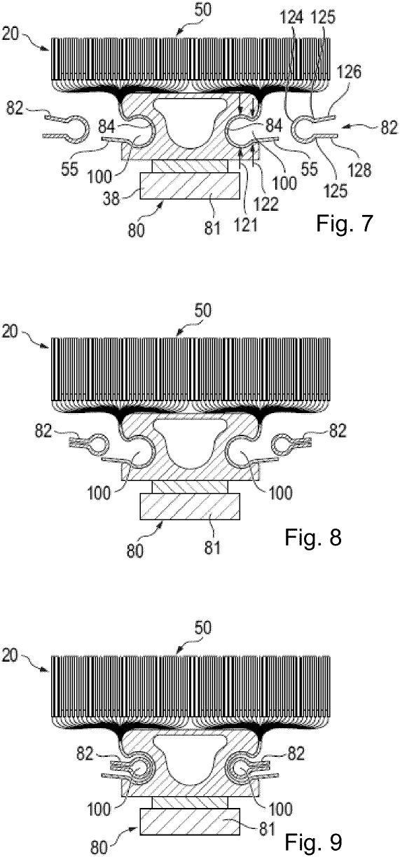

FIG. 7 shows the electrode stack assembly 50 of the battery cell 20, and the strip elements 55 of the first electrode assemblies 51 are bundled or placed side-by-side in order to form a first partial strip element stack and a second partial strip element stack. A clamping arrangement 80 has a base part 81, which base part 81 forms the connecting element 38. The base part 81 has a first contact face 84, which, in the embodiment example, is formed in a groove-like recess 100. The first strip elements 55 extend into the groove-like recess 100.

In the region of the groove-like recess 100, the base part 81 is concavely curved, at least in sections, in order to reduce the risk of damage to the first strip elements 55 or the second strip elements 56.

In an inner region, the groove-like recess 100 has at least in sections a first width 121, which is greater than a second width 122 in an outer region of the groove-like recess 100.

The base portion 81 comprises two groove-like recesses 100, which are formed on opposite sides of the base portion 81. Two counter-elements are shown in the unassembled, relaxed state outside of the groove-like recesses 100.

The counter-element 82 is configured as a profile part, which has a first curvature direction in the profile in a first curvature region 124 and comprises two free ends 126, 128.

Preferably, the counter-element 82 comprises in the profile between the first curvature region 124 and at least one of the free ends 126, 128, at least in sections, a second curvature region 125 having a second curvature direction, which second curvature direction is opposite to the first curvature direction.

FIG. 8 shows the battery cell 20 of FIG. 7 wherein the counter-elements 82 pressed together. For this purpose, for example, the free ends 126, 128 can be moved towards one another. The free ends 126, 128 can be configured comparatively long by the second curvature regions 125.

FIG. 9 shows the battery cell 20 of FIG. 8, wherein the counter-elements 82, which have pressed together, are inserted into the groove-like recesses 100.

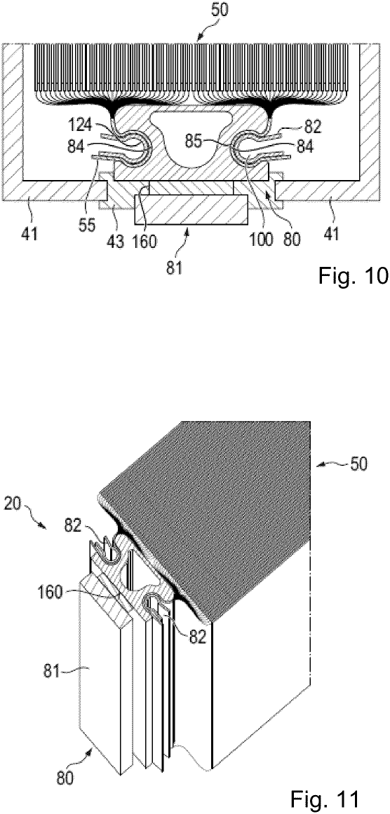

FIG. 10 finally shows the battery cell 20, wherein the counter-elements 82 are relaxed and thereby press the strip elements 55 against the first contact face 84. A clamping connection is formed between the base portion 81 and the counter-element 82, and the strip elements 55 are pressed against the first contact face 84.

The base part 81 is configured so as to be electrically conductive at least in regions, and thus the connecting element 38 can be electrically connected to the first electrodes 61 via the base part 81 and via the strip elements 55, cf. FIG. 6.

Due to the fact that the first width 121 in the inner region of the groove-like recess 100 is larger than the second width 122 in a further outer region of the groove-like recess 100 (cf. FIG. 7), a retaining effect of the counter-element 82 in the groove-like recess can be enabled. This can also be called an undercut. The counter-element 82 has a secure fit in the groove-like recess 100, and this provides a reliable connection. The first curvature region 124 (cf. FIG. 7) is arranged at least in sections in the groove-like recess 100, and the free ends 126, 128 protrude out of the groove-like recess 100. Preferably, the first curvature region 124 passes through an angular range of at least 185° in order to thereby be wider in a region in the groove-like recess 100 than in an outer region.

Schematically, the housing 30 is shown with the housing wall 41. The insulation element 43 is provided between the base part 81 and the housing wall 41 in order to bring about an electrical insulation. The housing 30 with the insulation element 43 can be pushed onto the base part 81, for example, and the base part 81 preferably has a groove 160 into which the insulation element 43 can engage. This also enables a good sealing.

FIG. 11 shows the battery cell 20 in a spatial view. The configuration of the base part 81 and the counter-elements 82 as profile parts is easily seen. The groove 160 is provided circumferentially about the base part 81 in the embodiment example, and this allows for a very good sealing.

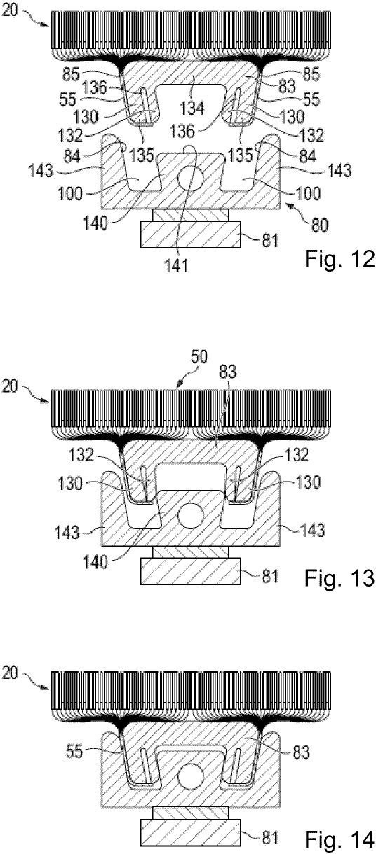

FIG. 12 shows a further embodiment of the base portion 81 and an associated counter-element 83. The counter-element 83 has two first protrusions 130 with first free ends 135, and the first protrusions 130 approach one another at least in sections towards the free ends 135. The base portion 81 has a protrusion 140 with a second free end 141, and the protrusion 140 widens at least in sections towards the free end 141. The base part 81 also has two third protrusions 143 forming the first contact face 84.

The first protrusions 130 are connected to one another by a connecting element 134. The counter-element thus has a U-shaped profile. The first protrusions 130 form the second contact face 85 on the side facing away from one another.

Preferably, the first protrusions 130 comprise a spring element 132, which is provided so as to allow for an increase of the distance between the two first protrusions 130 upon application of a force.

In the embodiment example, the protrusions 130 comprise a slot 136, which slot 136 is configured so as to allow the spring element 132 to be deflected into the region of the slot 136.

A groove-like recess 100 is formed between the second protrusion 140 and the third protrusions 143, respectively.

FIG. 13 shows a mounting step in which the base part 81 is moved towards the counter-element 83. Due to the formation of the second protrusion 140, the first protrusions 130 are pushed apart, and the spring elements 132 are deflected.

FIG. 14 shows battery cell 20, wherein the base part 81 is in the end state with respect to the position relative to the counter-element 83. The strip elements 55, which are positioned on the outside of the first protrusions 130, are pressed between the first contact face 84 and the second contact face 85. Due to the configuration of the second protrusion 140, the counter-element 83 seeks to penetrate further into the groove-like recess 100. As a result, a secure connection between these two parts is created by the base part 81 and by the counter-element 83, and there is a good clamping effect with respect to the strip elements 55 and thus a good contact between the base part 81 and the strip elements 55. According to this configuration, no additional pressing means is required, such as a screw, because the clamping effect is already provided by the configuration of the base part 81 and the counter-element 83.

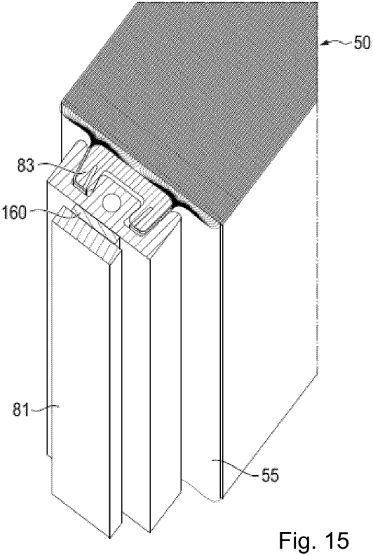

FIG. 15 shows the battery cell 20 of FIG. 14 in a spatial view. The profile-like configuration of the base part 81 and the counter-element 83 can be seen.

In the embodiment examples, the contacting was shown on the side of the strip elements 55. The contacting of the strip elements 56 preferably occurs in the same manner, but can also be occur differently.

Many variants and modifications are of course possible within the scope of the present invention.

1. A battery cell comprising:
a housing,
an electrode stack assembly, and
at least one terminal assembly,
wherein the electrode stack assembly is arranged in the housing and comprises first electrode assemblies and second electrode assemblies, which first electrode assemblies comprise first electrodes and first strip elements, which second electrode assemblies comprise second electrodes and second strip elements,
wherein the at least one terminal assembly comprises a base part and a counter-element, which base part comprises a first contact face, which counter-element comprises a second contact face, which counter-element resiliently engages with at least one groove recess of the base part in such a way that a first force is applied to the first contact face and the second contact fact, pushing them towards one another,
wherein the first strip elements or the second strip elements are arranged between the first contact face and the second contact face,
wherein the base part is electrically conductive and forms a connecting element, which connecting element is configured to be contacted from outside of the housing, and which base part is electrically connected to the first electrodes via the first strip elements or to the second electrodes via the second strip elements.

2. The battery cell according to claim 1, wherein the base part comprises two first contact faces, which are disposed on two opposite sides of the base part.

3. The battery cell according to claim 2, wherein the base part extends through the housing and forms a terminal element on the outside of the housing.

4. The battery cell according to claim 1, wherein the base part extends through a housing wall of the housing, and wherein the counter-element is arranged on an inside of the housing wall.

5. The battery cell according to claim 1, wherein the housing has a basic cuboid shape with a first housing side, a second housing side, a third housing side, a fourth housing side, a fifth housing side and a sixth housing side, which first housing side is provided opposite to the second housing side, which third housing side is provided opposite to the fourth housing side, and which fifth housing side is provided opposite to the sixth housing side.

6. The battery cell according to claim 5, wherein the at least one terminal assembly comprises a first terminal assembly and a second terminal assembly, in which the first terminal assembly is provided on the first housing side, and in which the second terminal assembly is provided on the second housing side.

7. The battery cell according to claim 1, wherein the base part comprises either copper or a copper alloy.

8. The battery cell according to claim 1, wherein the base part forms the first contact face in a region of the groove recess, in which the first strip elements or the second strip elements extend into the groove recess, and in which the counter-element is formed as a spring element with the second contact face, which counter-element extends at least in sections into the groove recess and resiliently abuts with the second contact face against the first contact face via the first strip elements or via the second strip elements.

9. The battery cell according to claim 8, wherein the groove recess comprises a first width in an inner region, at least in sections, which first width is greater than a second width in an outer region of the groove recess, in order to thereby enable a retaining effect of the counter-element in the groove recess.

10. The battery cell according to claim 8, wherein the base part comprises in the region of the groove recess a concave curvature, at least in sections, in order to reduce the risk of damage to the first strip elements or the second strip elements.

11. The battery cell according to claim 8, wherein the counter-element is configured as a profile part, which has a first curvature direction in the profile in a first curvature region and two free ends, wherein the first curvature region is arranged at least in sections in the groove recess and at least one of the free ends protrudes out of the groove recess, wherein both free ends protrude out of the groove recess.

12. The battery cell according to claim 11, wherein the first curvature region passes through an angular range of at least 185°.

13. The battery cell according to claim 11, wherein the counter-element comprises in the profile between the first curvature region and at least one of the free ends, at least in sections, a second curvature region having a second curvature direction, which second curvature direction is opposite to the first curvature direction.

14. The battery cell according to claim 1, wherein the counter-element comprises two first protrusions having first free ends, which first protrusions approach one another at least in sections towards the free ends, and in which the base part comprises a second protrusion having a second free end, which extends into the region between the two first protrusions and widens at least in sections towards the second free end in order to cause a clamping connection between the base part and the counter-element through the interaction of the first protrusions with the second protrusion.

15. The battery cell according to claim 14, wherein the base part comprises two third protrusions, in which the first protrusions each extend into a region between the second protrusion and the associated third protrusion, which third protrusions form the first contact face, which first protrusions form the second contact face, and which first contact face is subjected to a force by the clamping connection between the base part and the counter-element towards the second contact face, wherein the first strip elements or the second strip elements extend between the first contact face and the second contact face.

16. The battery cell according to claim 14, wherein at least one of the first protrusions comprises a spring element, which spring element enables an increase of a distance between the two first protrusions upon application of a force.

17. A battery cell according to claim 16, wherein at least one of the first protrusions comprises a slot, which slot is configured to allow the spring element to be deflected into a region of the slot.

18. A motor vehicle comprising the battery cell of claim 1.
